(19) United States
(12) Patent Application Publication
(10) Pub. No.: US 2026/0003758 A1
(43) Pub. Date: Jan. 1, 2026

(54) HIERARCHICAL AND DISTRIBUTED METRICS AGGREGATION USING NAMESPACES FOR MULTITENANT AUTONOMOUS CLOUD ENVIRONMENT

(71) Applicant: Oracle International Corporation, Redwood Shores, CA (US)

(72) Inventors: Manoj Dhanapal, Woodinville, WA (US); Nagarajan Muthukrishnan, San Ramon, CA (US); Ravi Shankar Thammaiah, Redwood City, CA (US)

(73) Assignee: Oracle International Corporation, Redwood Shores, CA (US)

(21) Appl. No.: 18/757,267

(22) Filed: Jun. 27, 2024

(51) Int. Cl. G06F 11/34; G06F 11/07

(52) U.S. Cl. CPC G06F 11/3409; G06F 11/0709; G06F 2201/80

(57) ABSTRACT

A computer program product, system, and computer implemented method for hierarchical and distributed metrics aggregation using namespaces for a multitenant autonomous cloud environment. The approaches disclosed herein generally comprise hierarchical and distributed metrics aggregation using namespaces for a multitenant autonomous cloud environment. The approaches provided herein are task and object based and use templates to generate metrics objects which include relevant metrics. The templates are associated with rules for their management which specify what, when, and how to modify said metrics. In some embodiments, the rules also specify how metrics in a metric object can be rolled up into another metrics object. The approach provided herein is dynamic and is tied to the lifetime of a corresponding task—e.g., the metrics object is created at the time of the instantiation of the task and is rolled up to a parent metrics object using namespaces when that task ends.

### BACKGROUND

Modern computing systems handle large amounts of data. For single user/device data storage systems this often corresponds to gigabytes and even terabytes of data. However, in the context of network environments, such as in a cluster, where multiple users or services are provided, the amount of data to be managed is often in the order of petabytes of data, or more, some of which may be shared by multiple users or used to provide services to multiple users. Unfortunately, the systems designed for individual users simply are not capable of efficiently handling the amount of data in these network environments.

One current approach to address the needs of network systems is to use pluggable databases such as in a consolidated database. This solves the problem of data management to a certain extent by allowing different pluggable databases to be open as needed in a consolidated database instance and even allows multiple users/services to operate on that data concurrently by allowing the same pluggable database to be open in multiple consolidated database instances at the same time. However, the use of consolidated databases presents another challenge in managing those consolidated databases.

Specifically, such large and complex systems still need to be managed appropriately. One facet of this is the collection and review of performance metrics. However, current techniques for metric collection and review do not allow for easy management or review. Instead, such approaches use fixed and cumbersome management techniques to maintain storage for collection of each and every metric in a single data structure even when many of those metrics are not applicable to a given process.

Therefore, there is a need for an improved approach to manage collection of metrics for consolidated databases in a cluster.

### SUMMARY

Embodiments of the present disclosure provide a method, apparatus, and product for hierarchical and distributed metrics aggregation using namespaces for a multitenant autonomous cloud environment.

The approaches disclosed herein generally comprise hierarchical and distributed metrics aggregation using namespaces for a multitenant autonomous cloud environment. Such approaches can be implemented at least as provided herein. For instance, the approaches provided herein are task and object based. Specifically, each task can be associated with one or more templates. Such templates can be used to generate metrics objects which include relevant metrics and are associated with rules for their management which specify what, when, and how to modify said metrics. In some embodiments, the rules also specify how metrics in a metric object can be rolled up into another metrics object (e.g., into a parent object, grandparent object, etc.). Generally, to allow for dynamic metric object creation and management, the approach provided herein is dynamic and is tied to the scope or lifetime of a corresponding task—e.g., the metrics object is created at the time of the instantiation of the task and is rolled up to a parent metrics object when that task ends. Furthermore, in some embodiments, metrics objects are associated with a retention policy that determines under what conditions a metric object will be captured for later review, and may further specify the conditions under which a corresponding metrics object should be discarded. In some embodiments, namespaces are used to enable template reuse and namespace redundancy by allowing for metrics to have the same name. In some embodiments, the process further simplifies rollup where values for metrics with the same name can be combined and where the namespaces are associated with the individual tasks or scopes.

Further details of aspects, objects and advantages of the disclosure are described below in the detailed description, drawings, and claims. Both the foregoing general description and the following detailed description are exemplary and explanatory and are not intended to be limiting as to the scope of the disclosure.

### BRIEF DESCRIPTION OF THE DRAWINGS

The drawings illustrate the design and utility of embodiments of the present disclosure, in which similar elements are referred to by common reference numerals. To better appreciate the advantages and objects of embodiments of the disclosure, reference should be made to the accompanying drawings. However, the drawings depict only certain embodiments of the disclosure, and should not be taken as limiting the scope of the disclosure. The drawings use like reference numerals to identify like elements, and unless otherwise specified, any description for that element may be applicable to each use of that reference numeral were appropriate.

FIG. 1A illustrates an example system in which some embodiments of the disclosure are implemented.

FIG. 1B illustrates example relationships between tasks and metrics objects according to some embodiments.

FIG. 1C illustrates an example arrangement for dynamic generation of metrics objects according to some embodiments.

FIG. 2 illustrates a flow for hierarchical and distributed metrics aggregation using namespaces for a multitenant autonomous cloud environment according to some embodiments.

FIG. 3 illustrates a flow for metrics object generation according to some embodiments.

FIG. 4 illustrates a flow for metrics object management upon closure of a task according to some embodiments.

FIGS. 5A-5L illustrate an example flow for dynamic object creation and management according to some embodiments.

FIGS. 6A-6B illustrate another example flow for dynamic object creation and management according to some embodiments.

FIG. 7 is a diagram of a computing system suitable for implementing an embodiment of the present disclosure.

FIG. 8 is a block diagram of one or more components of a system environment in which services may be offered as cloud services, in accordance with an embodiment of the present invention.

### DETAILED DESCRIPTION OF THE EMBODIMENTS OF THE DISCLOSURE

Various embodiments are described hereinafter with reference to the figures. It should be noted that the figures are not necessarily drawn to scale. It should also be noted that the figures are only intended to facilitate the description of the embodiment(s) and are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated. Additionally, as provided herein, unless otherwise indicated, the description of items identified by the same reference number are applicable to all instances of that item unless otherwise indicated herein.

Embodiments of the present invention comprise at least a computer-implemented method, a non-transitory computer readable medium, or a computing system for as provided herein. For instance, the approach might include maintaining metric definitions, metric generation logic, metric modification logic, and metric collection logic in addition to maintaining a consolidated database instance on a computing node in a cluster of computing nodes, wherein the consolidated database instance is associated with one or more pluggable database instances. Furthermore, this may include dynamically monitoring the consolidated database using one or more metrics objects generated at runtime for respective tasks based on metrics definitions, generation, modification, and collection logic, and processing the one or more metrics objects generated at runtime for individual tasks of the respective tasks upon close of the individual tasks. As provided herein a task may comprise any process executed by a CDB instance, a PDB, a session, a call, or an act. Each task may have a given scope, within which the corresponding metrics objects as discussed herein are created.

In some embodiments, dynamically monitoring the consolidated database using one or more metrics objects generated at runtime for respective tasks based on metrics definitions, generation, modification, and collection logic comprises at least generating one or more metrics objects at runtime for respective tasks based on metrics object definition templates. Furthermore, processing the one or more objects generated at runtime for individual tasks of the respective tasks upon close of the individual tasks may comprise rolling up metrics in the metrics object into another metrics object for a parent task. In some embodiments, templates and the metrics therein are defined in the code for the corresponding task(s).

In some embodiments, rolling up metrics in a metrics object into another metrics object for a parent task comprises adding an individual metric to a matching parent metric, where a parent task comprises an immediate parent. For instance, child metrics objects are rolled up into parent metrics objects based on at least matching metric labels.

In some embodiments, processing the one or more objects generated at runtime for individual tasks of the respective tasks upon close of the individual tasks comprises applying a retention policy to the metrics object, and the retention policy specifies conditions for storage or removal from storage of a corresponding metrics object. In some embodiments, metrics in a metrics object are rolled up into a parent metric in a periodic manner (e.g., based on a schedule or a time duration in which the metrics object existed.

In some embodiments, the approach comprises maintaining metric definitions, metric generation logic, metric modification logic, and metric collection logic; maintaining a database instance on a computing node; dynamically monitoring the database instance using one or more metrics objects, wherein the metrics objects are generated at runtime of individual tasks based on metrics definitions, generation, modification, and collection logic; and processing, based on hierarchical relationships between the one or more metrics objects, at least one task of the one or more tasks upon closing of the at least one task.

In some embodiments, database instances comprise consolidated database instances, the consolidated database instances are associated with one or more pluggable database instances, and a computing node is in a cluster of computing nodes. In some embodiments, generating metrics objects at runtime of the individual tasks is further based on metrics object definition templates.

In some embodiments, processing at least one task of the one or more tasks upon the closing of the at least one task comprises rolling up metrics in the metrics object into another metrics object for a parent task. In some embodiments, rolling up metrics in a metrics object into another metrics object for a parent task comprises adding an individual metric to a matching parent metric. In some embodiments, a parent task comprises an immediate parent and rolling up metrics in the metrics object into another metrics object for a parent task comprises adding an individual metric to a matching parent metric. In some embodiments, child metrics objects are rolled up into parent metrics objects based on matching metric labels.

In some embodiments, processing tasks upon the closing of the task comprises applying a retention policy to the metrics object, and a retention policy specifies conditions for storage or removal from storage of a corresponding metrics object.

As provided herein, the inventive aspects are discussed in the context of a consolidated database (CDB) having one or more pluggable databases (PDBs). However, the approaches provided herein could be used in the context of a general database. For instance, any database that supports concurrently active tasks (e.g., multiple sessions, calls, acts) could implement some or all of the approaches provided herein to more efficiently manage the resources used to monitor the database with regard to management and user tasks.

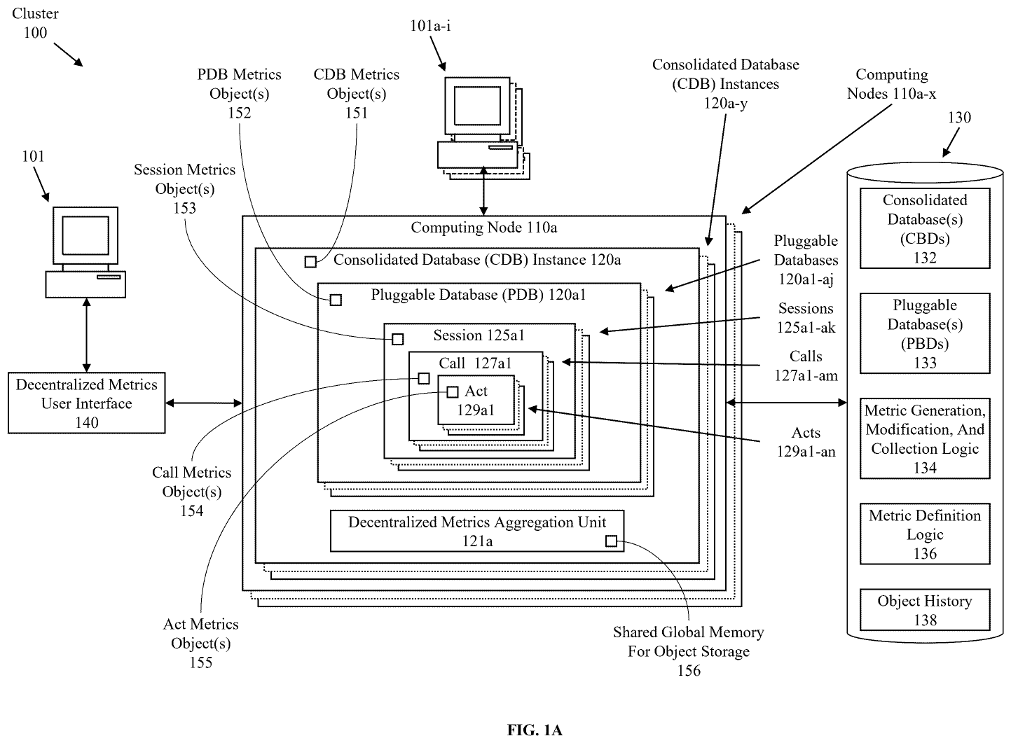

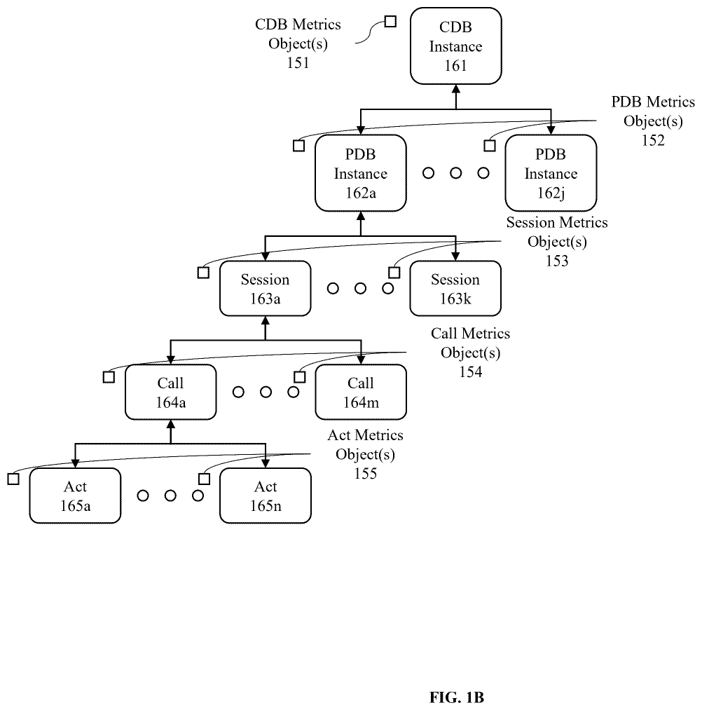

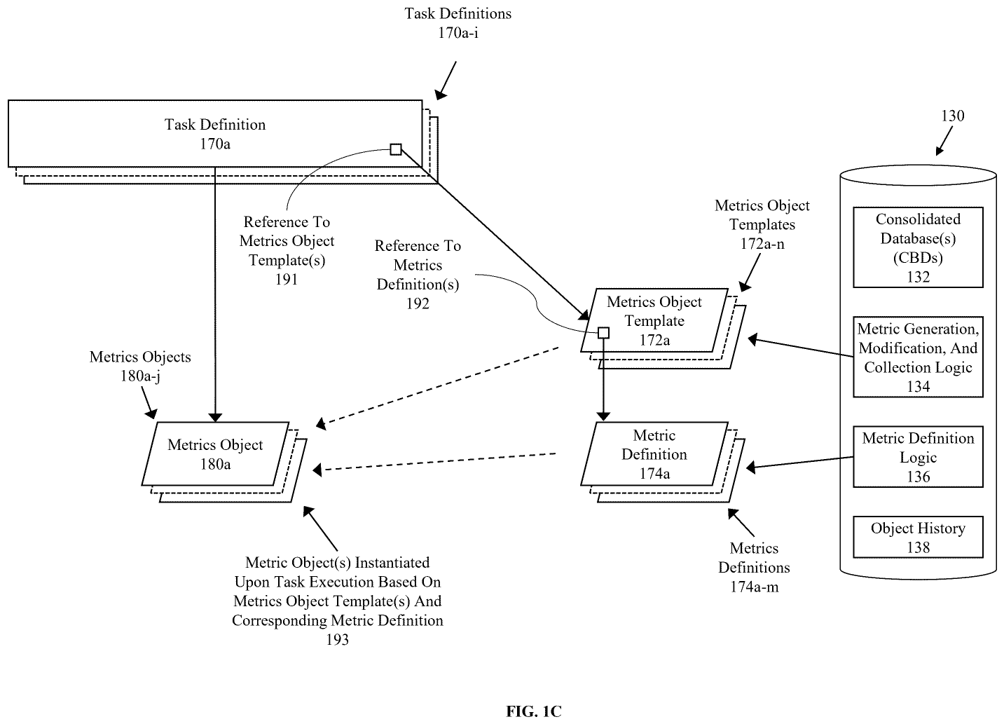

FIG. 1A illustrates an example system in which some embodiments of the disclosure are implemented. Generally, the system includes one or more computing nodes that can each include one or more consolidated database (CDB) instances which in turn include one or more pluggable databases (PDBs) that may be open in the consolidated database instance at any given time. Each CDB instance may further include one or more tasks that may be executed or are executing on the CDB instance. For example, each CDB might have a number of PDBs that are open, and each open PDB can have any number of sessions that access that PDB. Each session may in turn execute any number of calls and each call may execute one or more acts. Similarly, each call or act may comprise a nested call or act that initiates another call or act and so on. However, not all calls or acts are the same as other calls or acts. As a result, metrics that are relevant to one CDB, PDB, session, call, or act may differ from metrics that are relevant to another CDB, PDB, session, call, or act. As provided herein, a cluster may include a dynamic metric creation and management process as provided herein.

The system comprises a cluster 100 that includes a computer device 101, computing nodes 110a-x, a database 130, and a decentralized metrics user interface 140. Each computing node 110a-x might comprise one or more consolidated database instances-such as consolidated databases 120a-y as illustrated for computing node 110a—which might in turn have one or more pluggable databases (PDBs) open at any given time (see e.g., 120a1-aj). Each PDB may also have one or more open sessions for a respective PDB (see e.g., 125a1-ak), which in turn may make one or more calls (see e.g., 127a1-am), and which can spawn one or more acts (see e.g., 129a1-an). In some embodiments, each call or act may spawn one or more calls or acts in a recursive manner (e.g., to divide a task into multiple subtasks).

The computing devices 101a-i interact with consolidated database (CDB) instance(s) on respective nodes of the computing nodes 110a-x (e.g., 120a on computing node 110a) to interface with one or more computing nodes (see e.g., 110a-x) for initiation of tasks on respective PDBs—e.g., using one or more open sessions. Furthermore, the computing devices might be controlled by a user, another service, an administrator, or comprise any other computing device that allows data access or management of a CDB/PDB or an element therein. Any CDB instance can be associated with multiple PDBs and each CDB instance may have one or more open PDBs at any given time where the PDBs that are open on one CDB instance may or may not overlap with PDBs open in another CDB instance. A PDB itself is essentially a set of metadata and data where the metadata describes a schema, schema objects, and nonschema objects that can be presented on a network as a separate database. In some embodiments, one or more of the consolidated database instances (e.g., 120a1) comprises a container database or a collection of containers. In some embodiments, one or more of the PDBs comprise containers (e.g., partitions or virtual disks), which may be defined by a class, data structure, or an abstract data type. In some embodiments, the PDBs may comprise a container equivalent.

The computing devices 101a-i comprise any type of computing device that may be used to operate or interface with the CDB instance, whether directly or indirectly. Examples of such user computing devices 101 include workstations, personal computers, laptop computers, or remote computing terminals. User computing devices 101 may also comprise any type of portable tablet device, including for example, tablet computers, and portable readers. User computing device 101 may also include any mobile device that can suitably access any computing systems on the Internet such as smartphones and mobile handsets. It is noted that the disclosure is not limited in its application to just these types of devices. The embodiments of the disclosure are applicable to any computing device that works in conjunction with access to digital information stored on, as an example, the Internet. One of ordinary skill in the art may appreciate that embodiments of this present disclosure may be implemented on the Internet, on a closed network, on a hybrid open and closed network, or on a cloud network.

Additionally, a computing device (101) may be coupled to a decentralized metrics user interface 140. Specifically, such a computing device may be otherwise equivalent or even the same as one of the computing devices 101a-i. However, computing device 101 can interface with the decentralized metrics user interface 140 which allows for querying of current and historic information at any relevant level. For instance, historic metrics data may be maintained in one or more metrics objects (see e.g., 151-155) which may be captured in an object history (see e.g., 138). Additionally, current metrics data may be accessible for any task that has not finished execution by providing a mechanism for querying current metrics objects on any computing node with a relevant process (see computing nodes 110a-x). In some embodiments, current metrics objects may comprise merged metrics objects as will be discussed herein. Furthermore, current metrics objects may be maintained in a shared global memory for object storage (see 156) in a portion of a shared global memory of the consolidated database instance. In some embodiments, any or even all of computing devices 101a-i may also be capable of interfacing with the decentralized metrics user interface 140 to perform similar or the same functions.

Decentralized metrics user interface 140 may be provided in any location. For instance, the decentralized metrics user interface 140 may be provided on a standalone computing device, on a single computing node (e.g., 110a) or may be included in each of a plurality of computing nodes (see e.g., 110a-x). Moreover, in some embodiments, a decentralized metrics user interface can interface with one or more consolidated database instances to allow for querying and review of metrics objects in the object history (see 138), of metrics in the shared global memory (see e.g., 156) or any metrics associated with a currently executing or open task (see e.g., 151-155).

In some embodiments, the database 130 includes CDBs (132) and the corresponding PDBs (133). Additionally, as illustrated here, database 130 includes metric generation, modification, and collection logic 134. As will be discussed herein, the metric generation, modification, and collection logic 134 specifies the collection(s) of metrics to be used for monitoring respective tasks. Likewise, the metrics themselves are defined in the metric definition logic 136. As provided herein, the metric generation, modification, and collection logic 134 and the metric definition logic 136 may be embodied as separately referenceable specifications or code that can be referenced by corresponding tasks to manage lifecycles of metrics objects (see e.g., 151-155). In some embodiments, the metric generation, modification, and collection logic 134 and the metric definition logic 136 are embodied within the code for respective tasks. In some embodiments, the metric generation, modification, and collection logic 134 and the metric definition logic 136 are embodied within, or correspond to, features of which the tasks are a part. Regardless, upon the initiation of a task a corresponding metrics object is created and associated with that task (e.g., a first metrics object is created for a first task and a second object is created for a second task, a multiple metrics objects are created for a third task). Subsequently, metrics may be modified based on detectable events as defined by the metric modification logic 134, the metric definition logic 136, or a combination thereof. Finally, collection of the metrics in each respective object can be performed according to the metric modification logic 134, the metric definition logic 136, or a combination thereof. For instance, a metric might be defined to track a number of packets sent to or received at the consolidated database instance for a particular act (see e.g., act metrics object 155). Such a metric would then be increased, incremented, modified, or otherwise adjusted, every time an additional packet was sent to or received at the consolidated database instance for the completion of the act. Upon completion of the act, that metric might be rolled up to a preceding level (e.g., call or session) by adding the value to a like named value in an object associated with the act (e.g., call metrics object 154 or session metrics object 153). Likewise, there may be any number of metrics objects and each metrics object may have any number of metrics therein. In some embodiments, the metrics object is rolled up to any parent or parent's parent above the task's level—e.g., an act might be rolled up to a call, session, PDB, or CDB metrics object based on the metric generation, modification, and collection logic. For ease of reference a current task can be considered a child, and the child may have a parent (either immediate or otherwise). For instance, if an act is considered to be a child, the child's parents might comprise an immediate parent (e.g., a call) our another parent (e.g., grandparent/session, a great grandparent/PDB, or a great great grandparent/CDB instance). Additionally, in the case of a recursive operation or a call or act that triggers another call or act, the immediate parent is the parent that directly triggered the call or act and the next parent is the one that trigger the immediate parent and so on.

As illustrated here, a CDB instance (e.g., 120a) might comprise a decentralized metrics aggregation unit 121 and one or more open/openable pluggable databases (e.g., 120a1-an) which comprise data containers for user/customer/tenant data.

The decentralized metrics aggregation unit 121a may be associated with a shared global memory area. For instance, a shared global memory (156) may be utilized by the decentralized metrics aggregation unit to store metrics objects. In some embodiments, the metrics objects (see e.g., 151-155) are created in memory that is allocated to or associated with a particular task which the metrics represent. In some embodiments, the metrics objects (see e.g., 151-155) are created in memory that is shared by consolidated database instances and can be accessed by one or more processes with access to the shared global memory. In some embodiments, the decentralized metrics aggregation unit 121a can be used to send and receive metrics objects from one or more other consolidated database instances, whether on the same computing node or on a different computing node. For instance, a session on one computing node might be associated with one or more tasks that may be distributed across multiple consolidated data instances, whether on the same or different nodes,—e.g., a data replication task might be distributed as a plurality of subtasks such as calls or acts to one or more other consolidated database instances. In such an embodiment, the decentralized metrics aggregation unit is used to collect metrics objects for each of those subtasks—e.g., to rollup the corresponding metrics or to apply a metrics retirement policy to those metrics objects. Additionally, each session may result in one or more calls or tasks that are distributed across a collection of computing nodes (see e.g., 110a-x) having corresponding consolidated database instances (see 120a-y) to complete a job or execute a workload. In such an embodiment, the session may be the manager, orchestrator, leader, owner, master of the job or workload and may be associated with one or more processes (e.g., calls or acts) that cause the collection of relevant metrics as a result of the distributed calls or tasks on other computing nodes or CDB instances, where the distributed calls are executed by at least one or more workers, followers, or slaves.

In some embodiments, a consolidated database instance (see e.g., 120a) can have any number of pluggable databases (PDBs) open at a given time (see e.g., 120a1-aj and pluggable databases 133). Such PDBs may be accessed using one or more sessions (see e.g., 127a1-ak). Likewise, each session might be associated with a number of calls that execute either serially or in parallel (see e.g., 127a1-am). Each call may be associated with or spawn one or more acts (see 129a1-an), and each act may in turn spawn one or more other calls or acts in a recursive manner. Here, we refer to each CDB instance, open PDB instance, session, call, or act as a task. As provided herein, each task may be associated with one or more metrics objects which may be created at runtime (around the time that the corresponding task starts)—where the CDB instances, open PDBs, sessions, calls, and acts may be associated with one or more metrics objects (see CDB metrics object(s) 151, PDB metrics object(s) 152, session metrics object(s) 153, call metrics object(s) 154, and act metrics object(s) 155). Such metrics objects are generated based on a grouping or template as provided herein that is referenced by or included in the code for the task or a corresponding feature for which the task is at least a subset.

There are numerous metrics that could be tracked as provided herein. Any metric in the context of a CDB instance may be tracked. For example, metrics at the CBD level might comprise at least a number of PDBs opened or closed in the lifetime of a CDB instance. Metrics at the PDB might comprise at least a count of buffer cache misses by a PDB and a count of the number of sessions opened in context of that PDB. A metrics object at the level of a call might comprise a count of a number of acts initiated by the call. Metrics at the level of an act might comprise a count of a number of packets set and remote procedures executed. In some embodiments, the same metrics may be collected on multiple levels (e.g., number of I/O operations).

FIG. 1B illustrates example relationships between tasks and metrics objects according to some embodiments. Generally, the CDB instance, open PDBs, sessions, calls, and acts have a hierarchical relationship as illustrated herein according to some embodiments,

For instance, a CDB instance (see 161) might have one or more open PDB instances (see 162a-j). Likewise, an open PDB instance (see 162a) may be associated with one or more sessions (see 163a-k) at any given time. Additionally, a current session (see e.g. 163a) might have some number of pending calls (see 164a-m). Finally, a pending call (see e.g., 164a) might cause the creation of one or more acts (165a-n) to be performed. For clarity, we refer to each workload of these levels as a task (e.g., CDB instance, PDB instance, Sessions, calls, acts are all different examples of tasks). Additionally, though not illustrated in this figure, each call or act may create another call or act—e.g., to distribute a workload or to collect data or metadata from multiple sources and the like.

Additionally, each task is associated with one or more metrics objects which are generated along with the creation of, or as part of, the execution of the respective task. For instance, each task may include code or instructions which call a function that uses one or more parameters to determine what if any objects to generate and what form those objects should take. Together this can be referred to as a template where a template might include a group of metrics or multiple groups of metrics. In some embodiments, each task can be associated with any number of templates, where relevant templates are selected based on relevant parameters at the time of execution or instantiation of the task. For instance, a remote procedure call (RPC) connection might be associated with metrics to track a number of packets sent, a number of packets received, the amount of data sent and received, and the duration of the RPC connection. Each act that is executed for the RPC connection might track the same or different metrics (e.g., the same metrics in addition to a metric for action completion time). As each task is executed, the corresponding metrics are updated upon occurrence of a trackable or detectable event as defined according to metric generation, modification, and collection logic 134, metric definition logic 136, or some combination thereof. When the task finishes execution, crashes, or otherwise stops, the relevant metrics are rolled up as will be discussed herein. In this way, metrics are created and modified on a dynamic as needed basis, as opposed to a static basis (e.g., one with a predefined set of metrics regardless of conditions such as where all metrics that might be possible are created and managed at a session level even if only some of those metrics are or will be relevant to that particular session).

FIG. 1C illustrates an example arrangement for dynamic generation of metrics objects according to some embodiments. The example provides only one approach for creation of metrics objects and others may be practiced as provided herein.

Generally, each task is associated with a definition (see e.g., 170a-i) which defines the bounds of the capabilities and function of the task (e.g., the task can be defined by a set of instructions, a function call, an executable binary, etc.). For instance, a task to execute an SQL query might be associated with one or more steps that may in turn comprise other tasks to be executed. For instance, an SQL query might be parsed in a first task to ensure the query is property formatted, optimized in a second task, and executed using one or more other tasks. Any combination of functions or features may be associated with a task definition (e.g., code or instructions for execution of the task) and a reference to one or more metrics object templates (see 191). Based on any relevant parameters (e.g., user, client, account, database, function, feature, calling function, etc.) one or more templates (see 172a-n) can be selected (e.g., by reference see 191), where each template defines one or more objects, or groups of objects, to be created (see metrics objects 180a-j). Additionally, each metrics object template may reference (see 192) one or more metric definitions (see 174a-m).

The metrics object templates may define the generation, modification, and collection logic 134, and the metric definitions to be included therein (see 174a-m). In some embodiments, the templates can be generated in and operate as part of namespaces. There can be several benefits associated with using namespaces. The main benefit is organizational; when developing software applications with large codebases, it is important to have some way of organizing your code in an orderly fashion. Namespaces provide developers with an efficient and easy way to do this. Additionally, namespaces can also help reduce name conflicts when working with multiple libraries or classes. In this way, templates can be used to generate metrics objects (see 180a-j) that include metrics that are generated in different namespaces for ease of management and to allow reuse of metric definitions and templates. In fact, as provided herein, the namespaces can be leveraged to allow for the use of consistent names for metrics so that like identified metrics can be easily combined. Additionally, such metrics objects (see 180a-j) are generally instantiated upon task execution (see 193) and the namespaces can be used to separately maintain multiple different instances of metrics objects without conflict, even when the metrics in the namespaces are identified by the same label.

As illustrated here, the task definitions reference the metrics object templates (see 172a-n) that are stored in a database at 134 and comprise the metric generation, modification, and collection logic, and which in turn also reference metric definitions 174a-m that are also stored in the database at 136. However, in some embodiments, any combination of the metrics object templates (172a-n) and the metric definitions (see 174a-m) could be included in the task definition itself (e.g., in the code that forms the task).

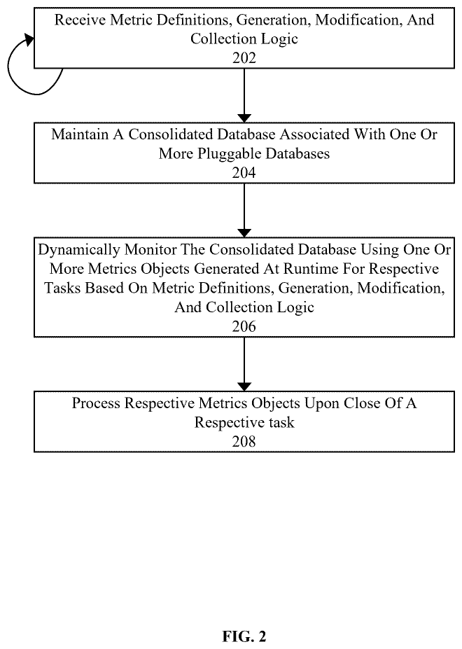

FIG. 2 illustrates a flow for hierarchical and distributed metrics aggregation using namespaces for a multitenant autonomous cloud environment according to some embodiments.

Generally, the process includes at least receipt of metric definitions, generation, modification, and collection logic at 202. Such process may be recursive and happen over time. For example, such information may be initially collected when a feature or task definition is created. At a later time, that information may be updated or modified (e.g., to account for new metrics, for new use cases, or to track new or different metrics in order to provide visibility into the functioning of a task or workload). For instance, each feature of a product (e.g., RPC, SQL, etc.) might be associated with one or more templates for tracking metrics. Such templates can be defined by at least a service, software provider, user/client, or feature. In some embodiments, a user may specify or request a metric to be tracked. Such information may be captured in the metric definitions, generation, modification, and collection logic. Upon execution of a feature or task therein, the corresponding metrics are managed on an as needed and dynamic basis.

Additionally, at 204, a consolidated database associated with one or more pluggable databases is maintained. As provided herein, the approach may be implemented in the context of a consolidated database. However, other uses are not precluded from practicing the approaches provided herein.

At 206, the consolidated database is dynamically monitored using at least the metric definitions, generation, modification, and collection logic. Such monitoring is implemented at the level of each task at runtime of respective tasks. For instance, upon instantiation of a task, a corresponding metric object(s) is created, where the relevant metrics are created and initialized (e.g., values are created with a given label in the corresponding namespace and set to a starting value such as zero). As the task executes, events that can be detected may also be tracked by the corresponding metric(s) such as packet exchanges, CPU cycles, memory utilization, etc. by incrementing, decrementing, or otherwise modifying the corresponding metrics based on a metric definition (see e.g., 136 and 174a-m).

Upon the close, completion, or ending of a task, at 208, the corresponding metric objects are processed. For instance, any metrics objects for a closed task are processed to perform rolling up of the included metrics into a parent (immediate or otherwise) and/or storing the corresponding object in a metric object history portion of a database (see e.g., object history 138). In this way the metric object history can be tracked and reviewed (e.g., at any time). Additionally, metric objects history many be periodically processed according to a set of archive management rules (e.g., metrics objects can be removed from the history based on various factors such as based on the creation time, available storage allocated to the object history, or a close of another process associated with the metric object(s)). In some embodiments, metrics may be purged from the object history based on a session close time or a PDB close time. In some embodiments, metrics may be periodically rolled up or rolled up based on a trigger even when the corresponding task is still live. In such an instance, the values of the metric and the metric object may be archived (e.g., stored in the object history) and may be reset to clear the metrics therein to initial values to avoid counting the same events multiple times.

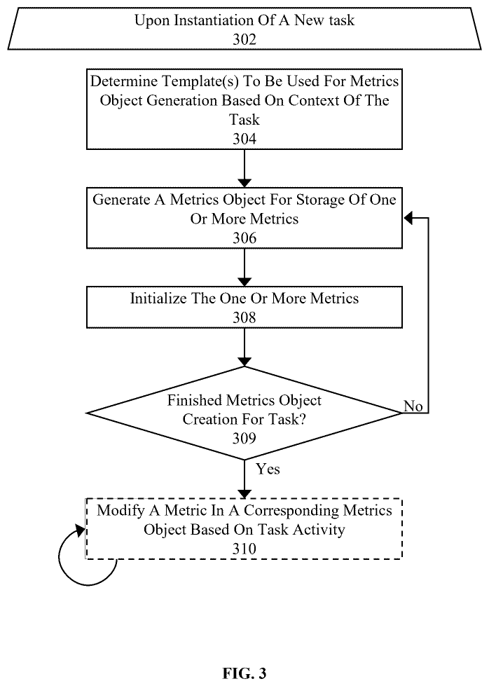

FIG. 3 illustrates a flow for metrics object generation according to some embodiments. However, other approaches could be utilized or the indicated operation could be completed in a different order from that illustrated.

The flow in FIG. 3 generally starts upon the instantiation of a new task at 302. For instance, each time a task is instantiated (e.g., upon a function or API call to execute a task) the indicated process may occur to generate one or more metrics objects. Each metrics object is generated in a namespace for the task for which the metrics object is generated to track. In this way metrics object templates can be used by any number of tasks as label name conflicts are not an issue for the metrics therein at least because of the namespace management techniques. Additionally, as is further discussed herein the label names can actually be used to match corresponding metrics across different tasks for rollup.

Upon instantiation, the template(s) to be used to generate one or more corresponding metrics object(s) are identified based on content of the task (see 304). For instance, the relevant template to use for the creation of the metrics objects is determined based on the task that caused the present task to be instantiated and the task to be completed by the called task. Additionally, one or more other parameters could be used to select a template for metrics object creation. In some embodiments, the templates themselves are dynamic and select or instantiate one or more metrics based one or more parameters associated with the tasks in a namespace for the task.

Generally, after template selection, each template is processed to generate the corresponding metrics object(s). For instance, a first metrics object is generated at 306. Such an object might be generated in memory allocated to the task or in a shared memory (e.g., a share memory of the PDB or CDB instance upon which the task executes. Each metric is initialized to a starting value. For instance, a metric is generally initialized to zero though any other value could be used. In some embodiments, the metric object generation process and the initialization may be combined into a single process. At 309 a determination is made as to whether the metrics object creation for the task has finished. For instance, it is determined whether all indicated metrics objects have been created and initialized based on a direct evaluation of the objects created and the templates referenced, or based on a process flow included in the task (e.g., upon return to the normal task execution process flow). In some embodiments, templates may specify groups of metrics to be include in a metrics object. In some embodiments, each group of metrics identified in a template is created in a separate metrics object. In some embodiments, the template to be used to generate a corresponding metrics object is selected using a switch statement that depends on the context of the task.

At 310, a metric in a corresponding metric object is modified based on task activity. This can be repeated as necessary to account for any task activity that is to be tracked. For instance, a monitoring flow could be utilized to detect events (e.g., packet sent, packet received, connection opened, connection closed). A metric might comprise a count, where upon detection of the corresponding action, the count is increased (e.g., by a fixed number or based on a formula such as by an amount of data that was sent or received). Additionally, in some embodiments, a metric might be modified based on a then current value retrieved in a periodic manner. For instance, a duration metric might be incremented on a periodic basis where, at a given frequency, a monitoring process determines whether the task or subtask is still alive and if so, increments the duration by the amount corresponding to the duration since an initial or last update.

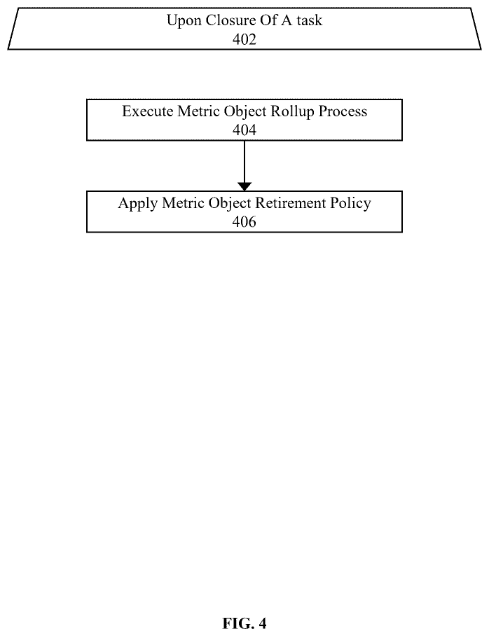

FIG. 4 illustrates a flow for metrics object management upon closure of a task according to some embodiments. Generally, each metrics object is processed upon the closure of the corresponding task to maintain a historical record of that metrics object and to update any parent (immediate or otherwise) based on the activity of the child task. Closure may be detected using any of one or more function calls, API calls, return statements, messages, process information, or any other relevant information indicating that the corresponding task is finished or is no longer operating. In some embodiments, metrics objects are periodically, or based on a triggering condition, rolled up to a corresponding parent (immediate or otherwise), reproduced in the object history, and reset to some initial value or values.

At 404 an object rollup process may be executed. Such a process may be initiated and managed based on relevant information. For example, a template might be associated with instructions for performing the object rollup and those functions may be triggered using a function call just prior to or upon return to a calling process. For instance, upon closure of a task a first flow is called to execute an object rollup process—e.g., by the task itself or a metrics object monitoring process. Object rollup processing may combine like identified metrics (e.g., metrics with matching label names), where a metric in the metrics object to be rolled up is added to, or combined with, a metric in a metrics object associated with a parent task (immediate or otherwise). For instance, a total number of packets sent in a child task might be added to a total number of packets sent in a metrics object for a parent task (e.g., call or session). In some embodiments, a metric in a metrics object might be added to a metrics object for a parent task, e.g., where that metric did not already exist in the metrics object corresponding to the parent task. Generally, a metric is rolled up into a metric object for a parent task by adding the value to a metrics object of the parent task. However, as this approach can be dynamic and programmatically controlled, the approach to rollup could be defined in any appropriate manner, such as by averaging, using a running average, using one or more weights, or any other techniques to combine values.

At 406, an object retirement policy may be applied. For instance, an object retirement policy might be used to specify which metrics objects are to be stored in an object history (see 138). For instance, every metrics object could be stored, or only metrics objects that meet a given condition(s) or do not meet a given condition(s) are stored. Additionally, the object retirement policy might specify the lifetime that a given metrics object is to be maintained in an object history (e.g., based on a time or storage, or based on a value specifying the expiration of the metrics object). In some embodiments, the metric object retirement policy removes the metric from the consolidated database upon storage of the metrics object in the object history—e.g., deletes the metrics object from corresponding shared global memory or task associated memory. Pseudocode example for hierarchical and distributed metrics aggregation using namespaces for a multitenant autonomous cloud environment might comprise the following:

A template can be defined at compile time prior to execution of a corresponding task. In some embodiments, a template may comprise a group of metrics. In some embodiments, multiple groups may be included in a template. For example, the template might comprise at least a definition of a group of metrics to be included in a metrics object (e.g., grp1 which is stat group 1) such as in the following:

#define grp1 STAT_GROUP_DN(grp1_)
STAT_GROUP_DV(grp1_, “stat group 1”, STAT_SCOPE_SESSION)

The STAT_GROUP_DN function provides a definition for a group which is identified as grp1 and the (grp1_) is used to create an internal object to be associated with the group. STAT_GROUP_DV is used to add an easily readable name (e.g., human readable name). For instance, grp1 is given a description of “stat group 1”, and a scope of the group is defined by STAT_SCOPE_SESSION clause which indicates that the group has the scope of the session. However, the session could be replaced with another any of the scopes provided herein (e.g., CDB, PDB, session, call, act).

Additionally, the metrics for the group can be defined and given a name (e.g., “stat_name 1” “stat_name 2”):

#define var1 STAT_VAR_DN(grp1_, var1_)
STAT_VAR_DV(grp1_, var1_, “stat_name 1”)
#define var2 STAT_VAR_DN(grp1_, var2_)
STAT_VAR_DV(grp1_, var2_, “stat_name 2”)

Similar to the previously pseudocode, the DN and DV suffixes can be used here in a similar manner to define a metric and to describe a metric. For example, a metric (see e.g., var1 or var2) can be defined using STAT_VAR_DN (see e.g., grp1_includes var1 and var2) and can be described using STAT_VAR_DV (e.g., var1 and var2 can be given easily readable names such as “stat_name 1” and “stat_name 2” or different names in place of “stat_name 1” and “stat_name 2”).

The definitions and descriptions provided above are generally completed at the time of coding of a task or at least prior to use of a task to create a group(s) of metrics to be included in a metrics object generated according to the template. For example, the above pseudocode includes the definition of a group which is included in a template where that group (grp1) has two metrics (var1 and var2). Multiple such groups can be defined for any one task where one or more other or even the same variables are defined.

During runtime, one or more metrics objects are instantiated using the groups or templates previously defined. For example, the code might be used to generate and control metrics objects. Metrics objects might be created at runtime such as follows:

stat_group_create(hdl1, grp1, “obj1”,);
stat_group_create(hdl2, grp1, “obj2”,);

As indicated above, two metrics objects are generated (named obj1 and obj2 respectively). Each object comprises the metrics specified in the grp1 template and are associated with handles hdl1 and hd12 respectively for a corresponding task. For example, a first session might be associated with hdl1 where obj1 is generated based on the template identified as grp1. Likewise, a second session might be associated with hdl2 where obj2 is generated based on the same template (grp1). Likewise, similar techniques could be used to generate any number of metrics objects associated with the same or different handles, templates, and object names.

In some embodiments, modification of a respective object requires, or can alternatively be accessed by, switching to that object (e.g., into its namespace). For instance, the context of the code path can be used to determine which metrics objects to switch to at any given time. For example, when switching between PDBs the process may also switch between metrics objects. One approach to manage this is to use a switch statement such as the one below which switches to the corresponding metrics object associated with the handle (here hdl1):
stat_group_switch (hdl1);

Even when multiple metrics objects are created using the same template, each object can be individually managed and may contain separate instances of essentially the same metric (e.g., each metrics object may be used to separately track the same activity such as packets sent). Once a monitoring process has switched to the given metrics object, values therein can be modified as illustrated below.

stat_set(var1, 0);
stat_set(var2, 1);
stat_inc(var1);
stat_inc(var2);

As provided above, the indicated pseudocode first sets var1 to zero and then sets var2 to 1. Such settings may correspond to initialization values. Likewise, one or more events might be detected that would implicate modification of variables in the group. For instance, stat_inc might be used to increment var1 and var2 to 1 and 2 respectively.

Similarly, a monitoring process might be used to switch to metrics obj2, where the metrics therein may be modified in a similar or the same manner as provided below.

stat_group_switch(hdl2);
stat_set(var1, 3);
stat_set(var2, 4);

Any number of metrics objects and metrics objects and metrics therein may be managed in this matter.

Similarly, the metrics objects can be rolled up by calling a corresponding function upon close of the task (e.g., function return execution) or based on a triggering event. For instance, the metrics objects of a child (hdl1) might be rolled up into a metrics object of a parent (hdl2) in response to the following function call:
stat_group_rollup (hdl2, hdl1);

In some embodiments, the rollup function is a simple additive based process, where the var1 in hdl1 is rolled up into var1 in hdl2 which in the present example equals 1+3=4. Likewise, the var2 in hdl1 is rolled up into var2 in hdl2 which in the present example equals 2+4=6. Such operations may be implemented using with or without switching. For example, the following could be used to add the hdl1 values to the hdl2 values:

stat_group_switch(hdl1);
stat_hdl_inc(hdl2, var1, var1);
stat_hdl_inc(hdl2, var2, var2);

As provided herein, stat_hdl_set( ) is a function that identifies the handle to be modified (here hdl2), the variable in the handle to be modified (var1) and the value to set the variable to (var1 of the currently active handle which is hdl1 in the present example, is set to the value of var1 in hdl1).

Similarly, a set operation could be used to set a value associated with a specific handle without switching to that handle (see below where var1 in hdl2 is set to the value of var1 in the currently open hdl1 and where var2 in hdl2 is set to 6).

stat_hdl_set(hdl2, var1, var1);
stat_hdl_set(hdl2, var2, 6);

Finally, after a retention policy is applied to the corresponding metrics objects (see hdl1 and hdl2), the metrics objects themselves can be archived and deleted (e.g., from memory associated with the process or from the shared memory as appropriate). Since each metrics object is independently created, the management, archival, and deletion of each metrics object can occur independently from other metrics objects (to the extent no express dependency is specified). Likewise, the template group definitions can be reused any number of times. For instance, metrics objects may be archived and deleted using at least following:

stat_group_archive(hdl1, policy1)
stat_group_delete(hdl1);
stat_group_archive(hdl2, policy2)
stat_group_delete(hdl2);

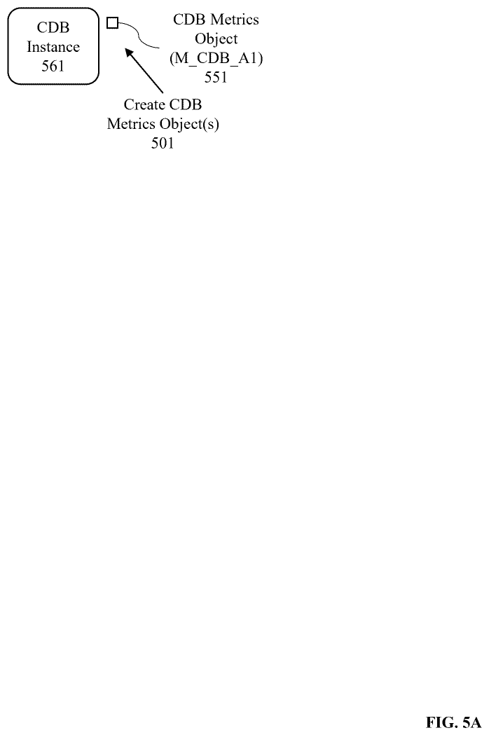

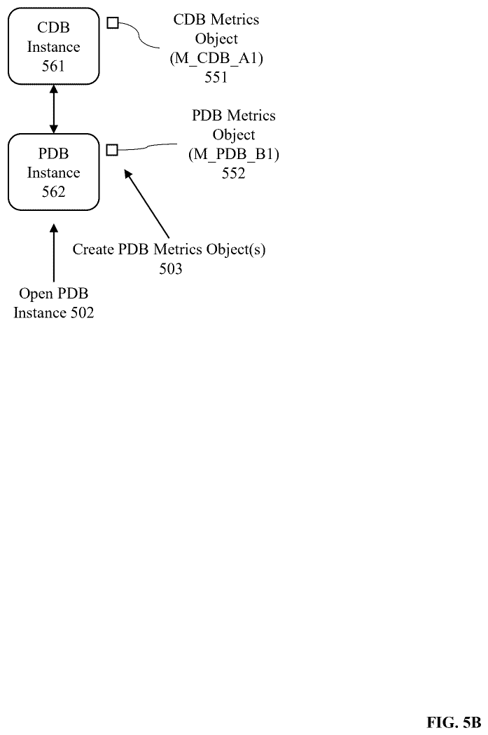

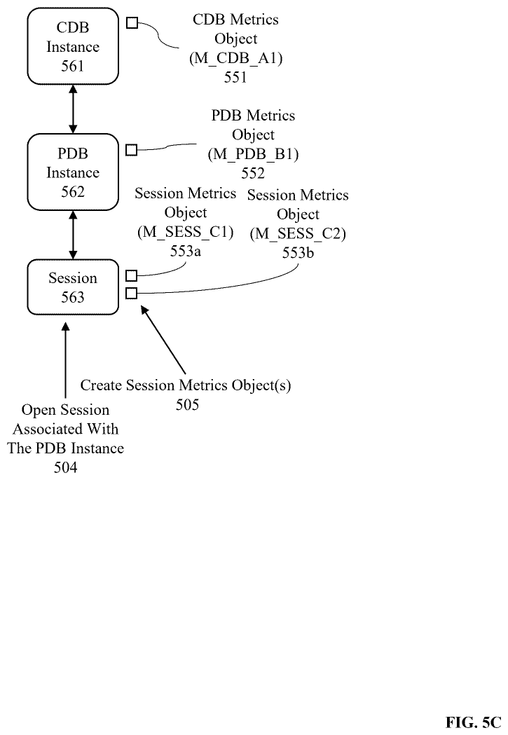

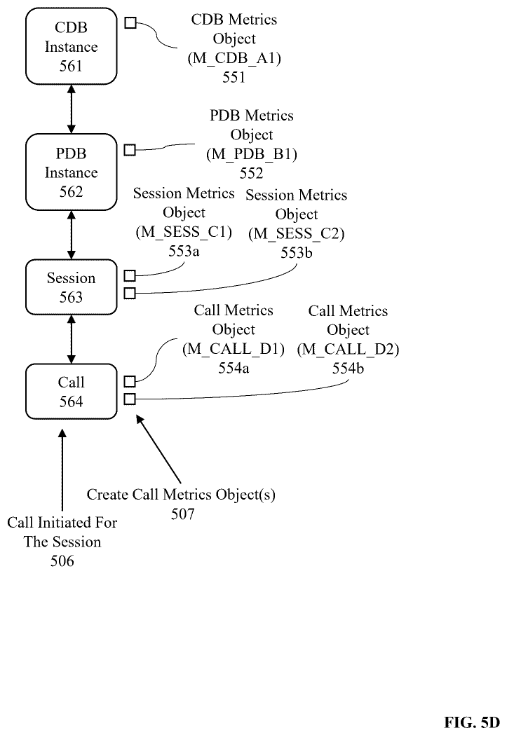

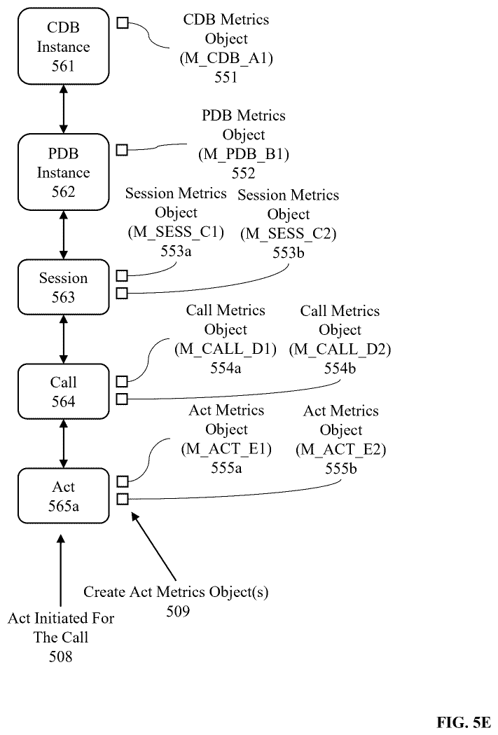

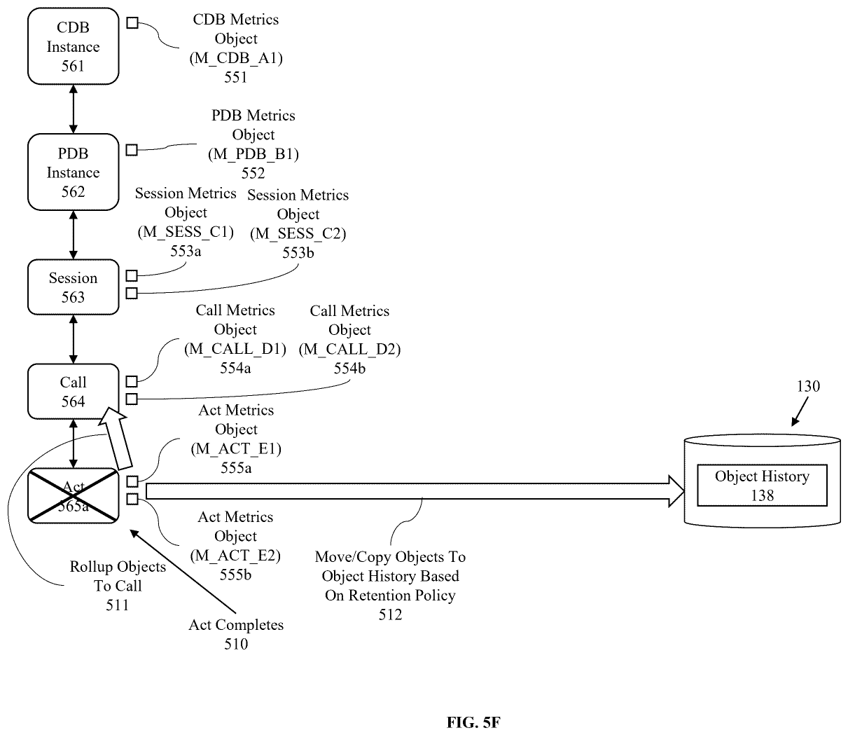

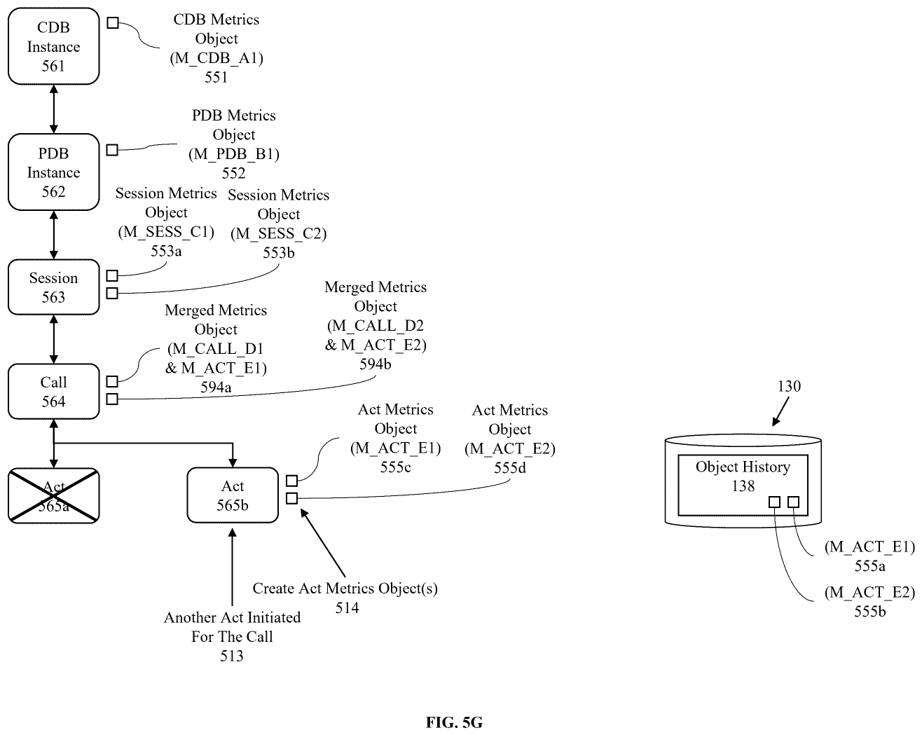

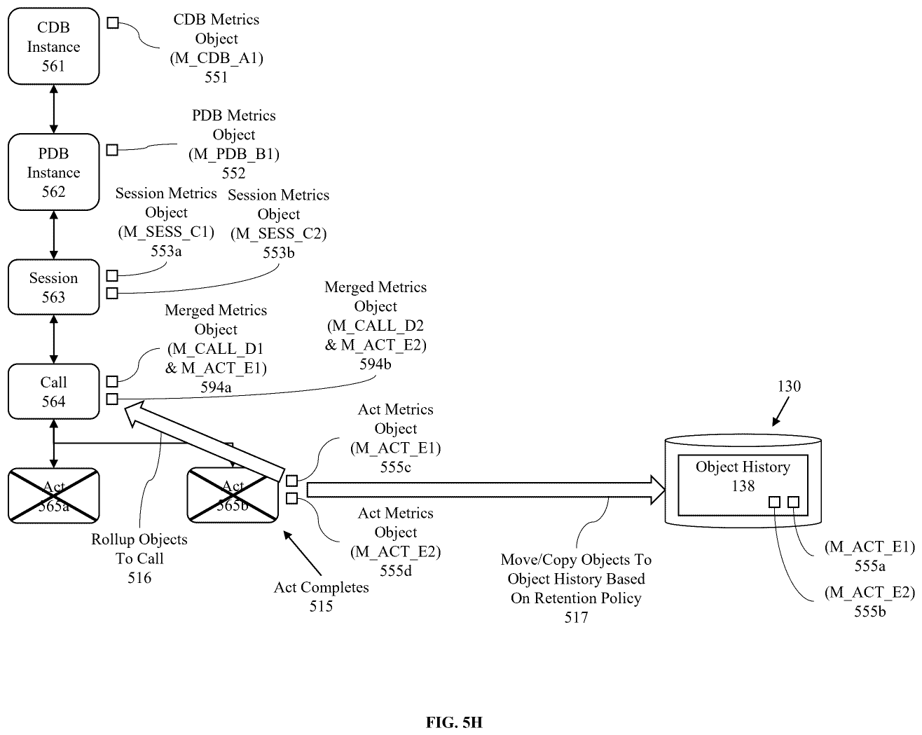

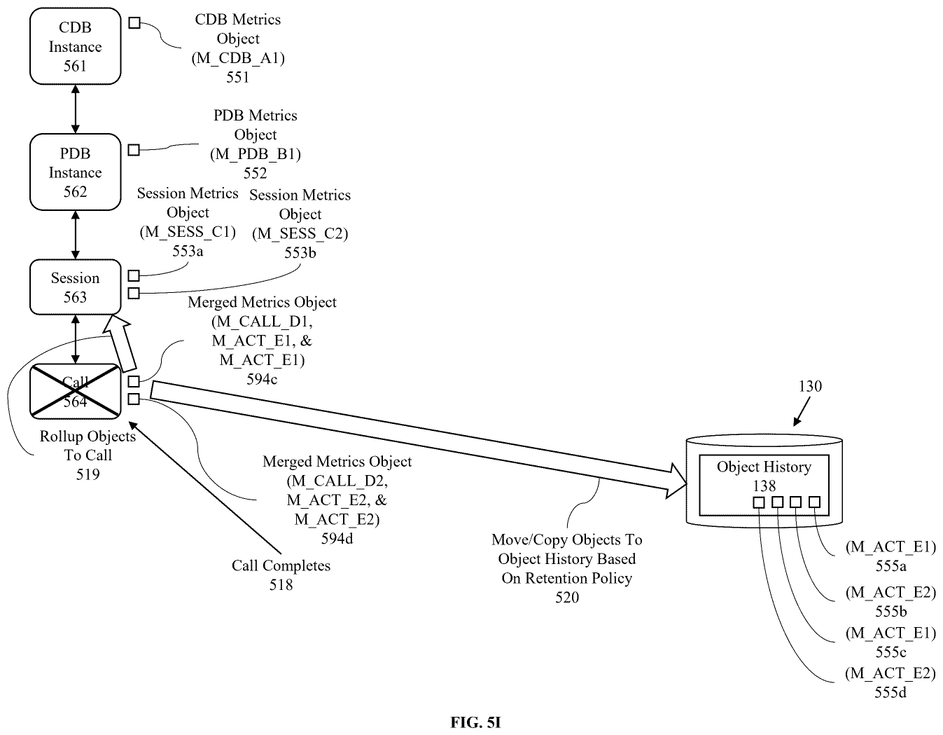

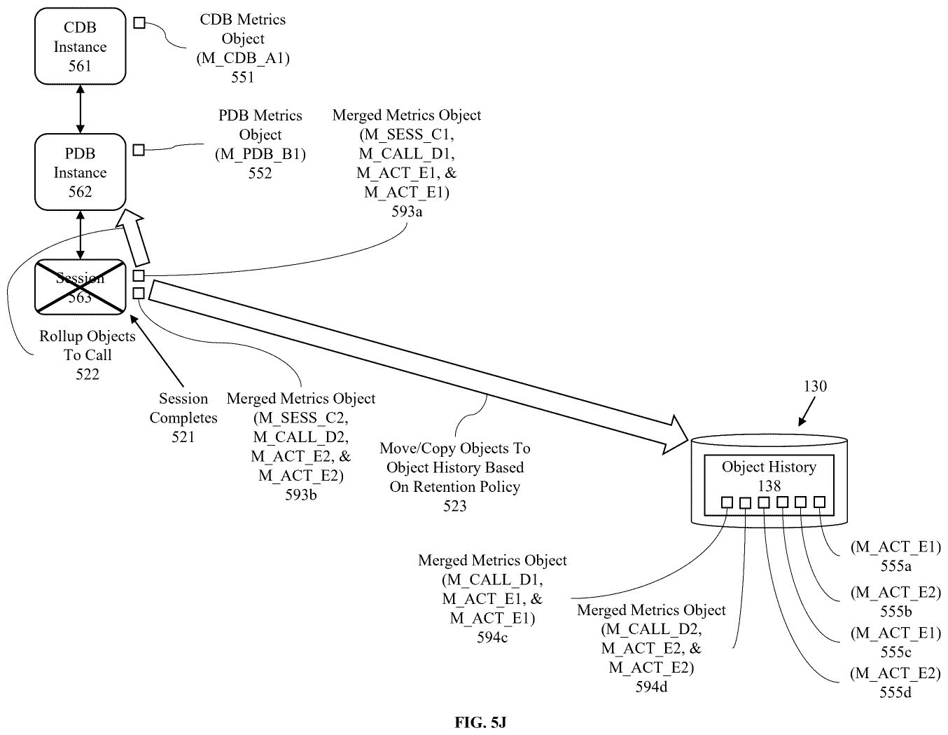

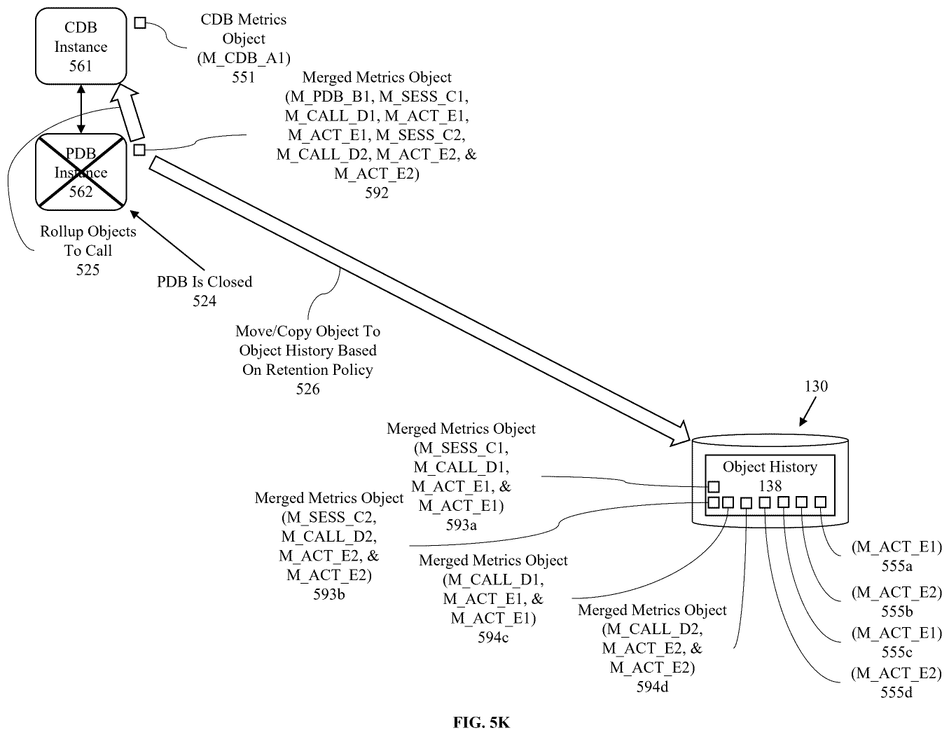

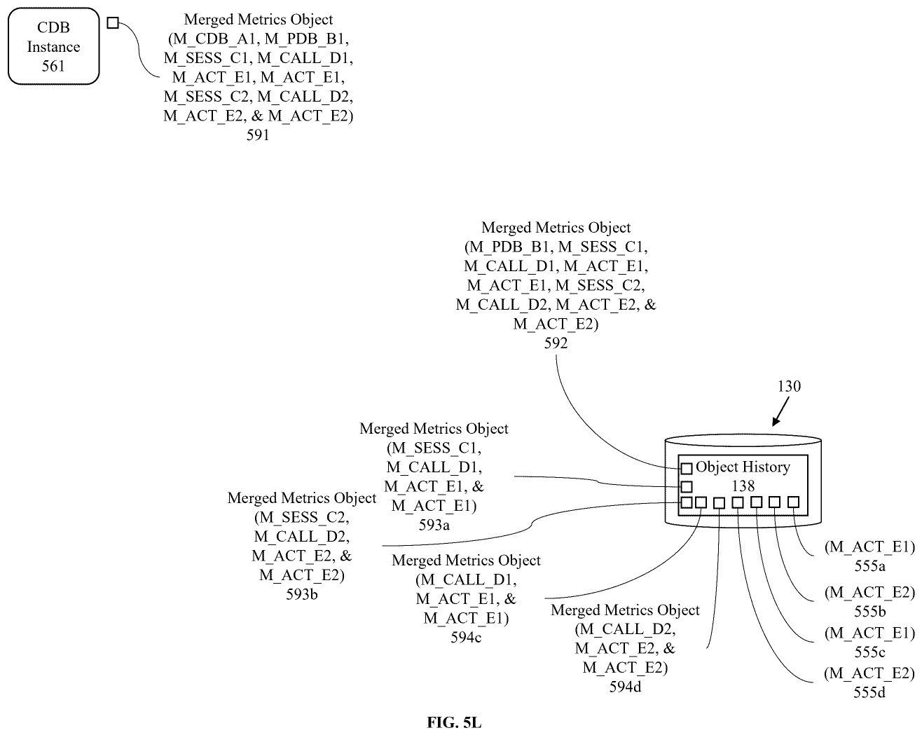

FIGS. 5A-5L illustrate an example flow for dynamic object creation and management according to some embodiments. The flow provided herein is but one example of a metrics object management flow as any number of dynamically created and managed metrics objects could be generated, modified, rolled up, and retired using any permutations of the techniques provided herein.

FIG. 5A illustrates an initial CDB state. Specifically, FIG. 5A illustrates a CDB instance 561 without any open PDB instances. Additionally, after or as part of CDB instantiation the approaches provided herein might be used to generate a CDB metrics object (M_CDB_A1) as identified at 501 and 551. Such a metrics object might be created to include one or more groups of metrics as provided herein based on at least one template. Additionally, though not illustrated here, there can be any number of CDB metrics objects created.

FIG. 5B illustrates the opening of a PDB instance (see 502 and 562). Specifically, FIG. 5B illustrates a PDB instance 562 that has been opened on the CDB instance but which is not yet associated with a current session. Additionally, after or as part of PDB instantiation the approaches provided herein are used to generate a PDB metrics object (M_PDB_B1) as identified at 503 and 552. As with the metrics object(s) created for the CDB instance, there could be any number of PDB metrics objects created though only one is illustrated here.

FIG. 5C illustrates the opening of a session corresponding to the PDB instance (see 504, 562, and 563). Specifically, FIG. 5C illustrates a session (563) associated with the PDB instance (562). Additionally, after or as part of session instantiation the approaches provided herein are used to generate session metrics objects (M_SESS_C1 & M_SESS_C2) as identified at 505 and 553a-b. As before, there can be any number of metrics object(s) created though two are illustrated here for the purposes of this example.

FIG. 5D illustrates a call (see 564) initiated by the session (see 563) at 506. Specifically, FIG. 5D illustrates a call (564) initiated as part of the session (563) associated with the PDB instance (562). As before, the call may be associated with any number of metrics objects, with two being illustrated here (see 507 and call metrics objects M_CALL_D1 & and M_CALL_D2) as identified at 554a-b.

FIG. 5E illustrates an act (see 565a) initiated by the call (see 564) at 508. Specifically, FIG. 5E illustrates an act (565a) initiated as part of the call (564) associated with the session (563). As before, the act may be associated with any number of metrics objects, with two being illustrated here (see 509 and act metrics objects M_ACT_E1 & and M_ACT_E2) as identified at 555a-b.

FIG. 5F illustrates the completion of the act which was initiated as illustrated in FIG. 5E (see 510). The act may be completed in any way as discussed herein. Upon the completion of the act, a rollup process is started (see 511). This process rolls the metrics in any metrics objects for the child (act) into a parent (call) metrics object (see 555a-b which are rolled up into the metrics objects of the immediate parent 554a-b). Additionally, the retention policy (see 512) is applied to the metrics objects to cause the movement (or copying and removal) of the metrics objects to the object history 138.

FIG. 5G illustrates the results of the rollup operations and the retention policy application to the corresponding metrics objects.

As illustrated, the rolling up of the metrics objects for the child (act) (see 555a-b from FIG. 5F) into the metrics object for the parent (call) (see 554a-b from FIG. 5F) has resulted in a merged metrics object (see merged metrics object 594a comprising a combination of the metrics from the parent and the child (M_CALL_D1 & M_ACT_E1) and merged metrics object 594b comprising a combination of the metrics from the parent and the child (M_CALL_D2 & M_ACT_E2)). As a general matter, merger does not normally create a new object but is instead a modification of the parent object to incorporate the information from the child. However, for ease of understanding they have been illustrated as different metrics objects herein. Mergers can be completed in any way as specified by the corresponding metric generation, modification, and collection logic (See 134). Such logic generally specifics that like named metrics in the child are added to like named metrics in the parent. To the extent that a metric is included in the child but not included in the parent, the metric can be added to the parent. In contrast, if a metric is in the parent but not in the child, the metric will not be modified by the merger process. In some embodiments, a metrics object for a child and the metrics object for a parent are two different instances generated using the same template—e.g., both metrics objects include the same metrics and metrics definitions.

Application of the retention policy discussed in the previous figure (see FIG. 5F and 512) results in the reproduction of the corresponding metrics objects (see 555a-b) in the object history 138. Such reproduced metrics objects will be retained in the objects history until a condition is met for their removal based on the retentions policy (e.g., they will be removed when a specified period of time has passed, based on a prioritization, based on at least an available capacity, based on an amount of storage allocated to the retention of metrics objects, or some combination thereof).

FIG. 5G also illustrates another act (see 565b) initiated by the call (see 564) at 513. Specifically, the act (565a) is initiated as part of the call (564) associated with the session (563). As before, the act may be associated with any number of metrics objects, with two being illustrated here (see 514 and act metrics objects M_ACT_E1 & and M_ACT_E2) as identified at 555c-d.

FIG. 5H also illustrates the completion of the act (see 565b) initiated as illustrated in FIG. 5G (see 515). The act may be completed in any way as discussed herein. Upon the completion of the act, a rollup process is started (see 516). This process rolls the metrics in any metrics objects for the child (act) into a parent (call) metrics object (see 555c-d which are rolled up into the metrics objects of the immediate parent 594a-b). Additionally, the retention policy is applied (see 517) to the metrics objects to cause the movement (or copying and removal) of the metrics objects to the object history 138.

FIG. 5I illustrates the results of the rollup operations and the retention policy application to the corresponding metrics objects.

As illustrated, the rolling up of the metrics objects for the child (act) (see 555c-d from FIG. 5H) into the metrics object for the parent (call) (see 594a-b from FIG. 5H) has resulted in a merged metrics object (see merged metrics object 594c comprising a combination of the metrics from the parent and the child (M_CALL_D1, M_ACT_E1, & M_ACT_E1) and merged metrics object 594d comprising a combination of the metrics from the parent and the child (M_CALL_D2, M_ACT_E2, & M_ACT_E2)). As a general matter, merger does not necessarily create a new object but is instead a modification of the parent object to incorporate the information from the child. However, for ease of understanding they have been illustrated as different metrics objects herein.

Application of the retention policy discussed in the previous figure (see FIG. 5H and 517) results in the reproduction of the corresponding metrics objects (see 555c-d) in the object history 138. Such reproduced metrics objects will be retained as discussed herein.

FIG. 5I also illustrates the completion of the call (see 564) initiated as illustrated in FIG. 5G (see 518). The call may be completed in any way as discussed herein. Upon the completion of the call, a rollup process is started (see 519). This process rolls the metrics in any metrics objects for the call into a parent metrics object (see 594c-d which are rolled up into the metrics objects of the immediate parent 553a-b). Additionally, the retention policy is applied (see 520) to the metrics objects to cause the movement (or copying and removal) of the metrics objects to the object history 138.

FIG. 5J illustrates the results of the rollup operations and the retention policy application to the corresponding metrics objects.

As illustrated, the rolling up of the metrics objects for the child (call) (see 594c-d from FIG. 5I) into the metrics object for the parent (session) (see 553a-b from FIG. 5I) has resulted in a merged metrics object (see merged metrics object 593a comprising a combination of the metrics from the parent and the child (M_SESS_C1, M_CALL_D1, M_ACT_E1, & M_ACT_E1) and merged metrics object 593b comprising a combination of the metrics from the parent and the child (M_SESS_C2, M_CALL_D2, M_ACT_E2, & M_ACT_E2)).

Application of the retention policy discussed in the previous figure (see FIGS. 51 and 520) results in the reproduction of the corresponding metrics objects (see 594c-d) in the object history 138. Such reproduced metrics objects will be retained as discussed herein.

FIG. 5J also illustrates the completion of the session (see 563) initiated as illustrated in FIG. 5C (see 518). The session may be completed in any way as discussed herein. Upon the completion of the session, a rollup process is started (see 522). This process rolls the metrics in any metrics objects for the child (session) into a parent (PDB) metrics object (see 593a-b which are rolled up into the metrics object of the immediate parent 552). Additionally, the retention policy is applied (see 523) to the metrics objects to cause the movement (or copying and removal) of the metrics objects to the object history 138.

FIG. 5K illustrates the results of the rollup operations and the retention policy application to the corresponding metrics objects.

As illustrated, the rolling up of the metrics objects for the child (session) (see 593a-b from FIG. 5J) into the metrics object for the parent (PDB) (see 552 from FIG. 5J) has resulted in a merged metrics object (see merged metrics object 592 comprising a combination of the metrics from the parent and the children (M_PDB_B1, M_SESS_C1, M_CALL_D1, M_ACT_E1, M_ACT_E1, M_SESS_C2, M_CALL_D2, M_ACT_E2, & M_ACT_E2)).

Application of the retention policy discussed in the previous figure (see FIGS. 5j and 523) results in the reproduction of the corresponding metrics objects (see 593a-b) in the object history 138. Such reproduced metrics objects will be retained as discussed herein.

FIG. 5K also illustrates the closing of the PDB instance (see 562) initiated as illustrated in FIG. 5B (see 524). Upon the closure of the PDB instance, a rollup process is started (see 525). This process rolls the metrics in any metrics objects for the child (PDB) into a parent (CDB) metrics object (see 592 which is rolled up into the metrics object of the immediate parent 551). Additionally, the retention policy is applied (see 526) to the metrics object to cause the movement (or copying and removal) of the metrics objects to the object history 138.

FIG. 5L illustrates the results of the rollup operations and the retention policy application to the corresponding metrics objects.

As illustrated, the rolling up of the metrics objects for the PDB instance (see 592 from FIG. 5K) into the metrics object for the CDB instance (see 551 from FIG. 5K) has resulted in a merged metrics object (see merged metrics object 591 comprising a combination of the metrics from the parent and the children (M_CDB_A1, M_PDB_B1, M_SESS_C1, M_CALL_D1, M_ACT_E1, M_ACT_E1, M_SESS_C2, M_CALL_D2, M_ACT_E2, & M_ACT_E2)).

Application of the retention policy discussed in the previous figure (see FIG. 5K and 526) results in the reproduction of the corresponding metrics objects (see 592) in the object history 138. Such reproduced metrics objects will be retained as discussed herein.

As provided herein, the approaches illustrated in FIGS. 5A-5L can be used to manage any combination of tasks by generating one or more corresponding metrics objects upon the start (e.g., opening or instantiation) of a task, and the closing or ending of the task to manage the creation, rollup, and retention of metrics objects. Additionally, during operation of a respective task, each metric can be modified in any appropriate manner to track activity of the task. In this way the metrics objects can be used to maintain a history of metrics objects that capture relevant characteristics of tasks. Additionally, the rollup of the metrics objects for children of parents into their parent (immediate or otherwise) can be used to appropriately attribute the activity of a child task to that of a parent task.

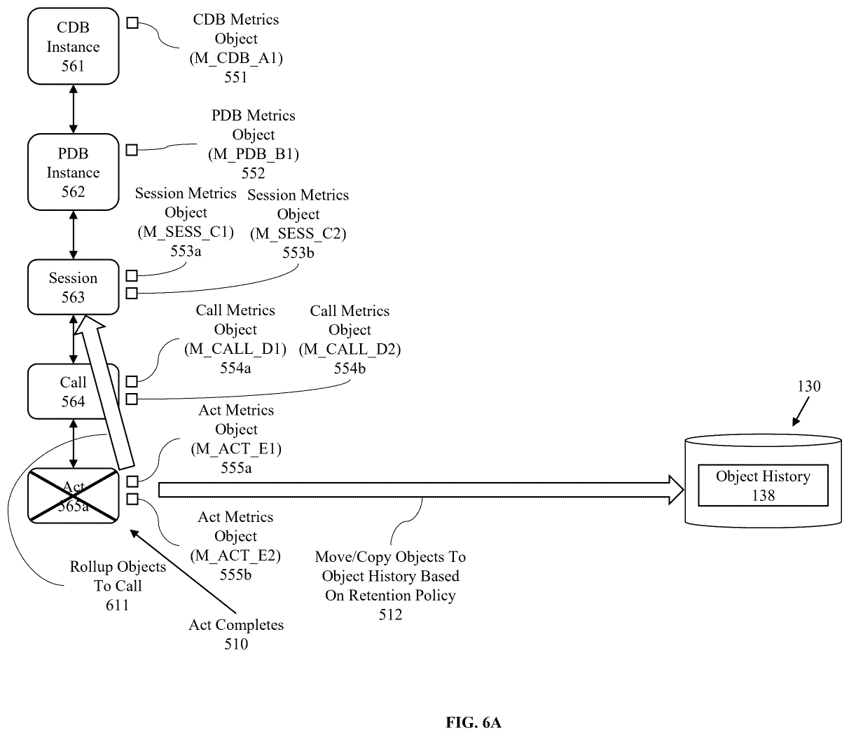

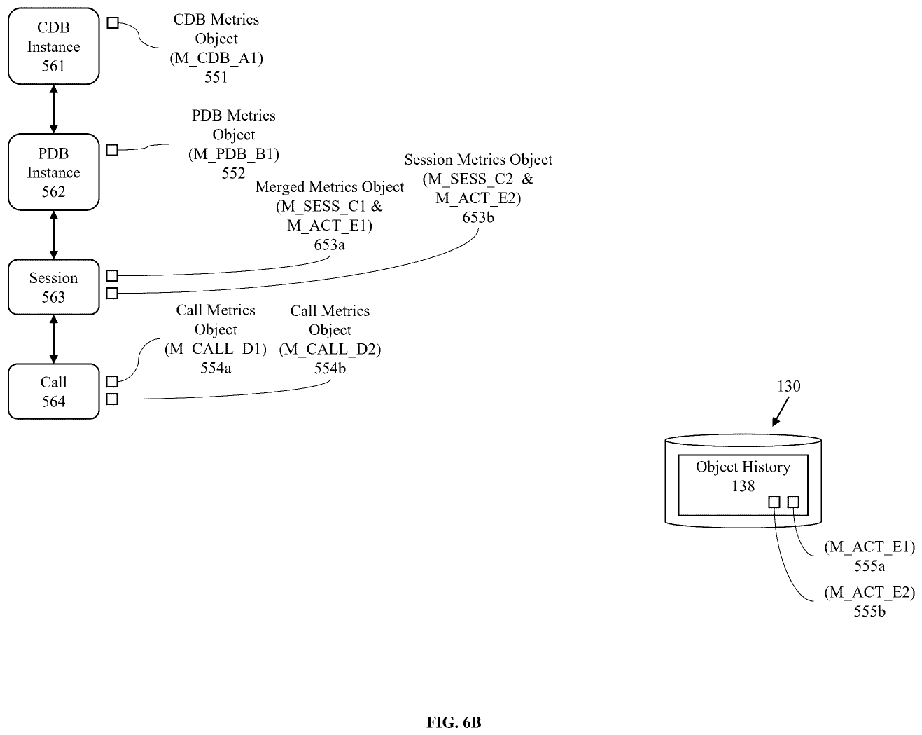

FIGS. 6A-6B illustrate another example flow for dynamic object creation and management according to some embodiments. Generally, the approaches illustrated in FIGS. 6A-6B are the same as provided in FIGS. 5A-5L. However, FIGS. 6A-6B illustrates metrics objects for a child (act) that are rolled up to a metrics object for a parent (session) which is not an immediate parent (e.g., here it is a parent's parent or the child's grandparent).

Specifically, descriptions of like referenced numerals are provided in regard to FIGS. FIGS. 5A-5L. Additionally, FIG. 6A continues the example illustrated in FIG. 5E.

FIG. 6A illustrates the completion of the act initiated as illustrated in FIG. 5E (see 510). The act may be completed in any way as discussed herein. Upon the completion of the act, a rollup process is started (see 611). This process rolls the metrics in any metrics objects for the child (act) into its grandparent (session) metrics object (see 555a-b which are rolled up into the metrics objects of the grandparent 553a-b) which is associated with the session in which the act executes. Additionally, the retention policy (see 512) is applied to the metrics objects to cause the movement (or copying and removal) of the metrics objects to the object history 138 and out of the shared memory (e.g., 156).

FIG. 6B illustrates the results of the rollup operations and the retention policy application to the corresponding metrics objects.

As illustrated, the rolling up of the metrics objects for the child (act) (see 555a-b from FIG. 6A) into the metrics object for the grandparent (session) (see 553a-b from FIG. 6A) has resulted in a merged metrics object (see merged metrics object 653a comprising a combination of the metrics from the parent and the child (M_SESS_C1 & M_ACT_E1) and merged metrics object 653b comprising a combination of the metrics from the parent and the child (M_SESS_C2 & M_ACT_E2)). As a general matter, merger does not necessarily create a new object but is instead a modification of a parent object to incorporate the information from the child. However, for ease of understanding they have been illustrated as different metrics objects herein. As provided herein, mergers can be completed in any way as specified by the corresponding metric generation, modification, and collection logic (See 134). Such logic generally specifics that like named metrics in the child are added to like named metrics in an immediate parent or a progenitor parent (grandparent, great grandparent, etc.). To the extent that a metric is included in the child but not included in the parent, grandparent, great grandparent, etc., the metric can be added to the parent, grandparent, great grandparent, etc. In contrast, a metric that is in the parent, grandparent, great grandparent, etc., but not in the child, will not be modified by the merger process unless it corresponds to the act of rolling up the metrics object itself.

Application of the retention policy discussed in the previous figure (see FIG. 6A and 512) results in the reproduction of the corresponding metrics objects (see 555a-b) in the object history 138. Such reproduced metrics objects will be retained in the objects history until a condition is met for their removal based on the retentions policy as disclosed here.

### System Architecture

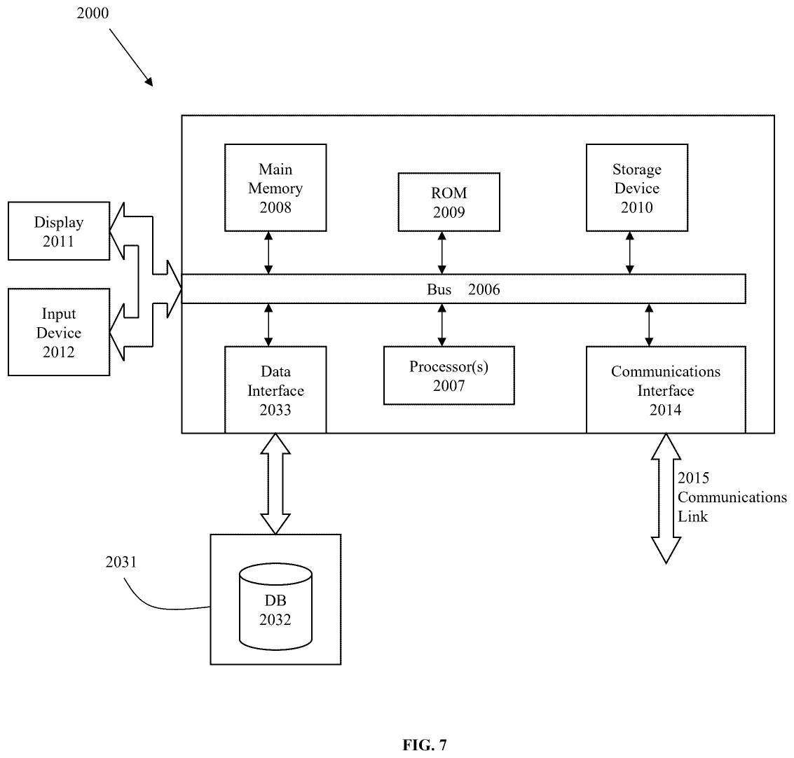

FIG. 7 is a block diagram of an illustrative computing system 2000 suitable for implementing an embodiment of the present invention. Computer system 2000 includes a bus 2006 or other communication mechanism for communicating information, which interconnects subsystems and devices, such as processor 2007, system memory 2008 (e.g., RAM), static storage device 2009 (e.g., ROM), disk drive 2010 (e.g., magnetic or optical), communication interface 2014 (e.g., modem or Ethernet card), display 2011 (e.g., CRT or LCD), input device 2012 (e.g., keyboard), and cursor control.

According to one embodiment of the invention, computer system 2000 performs specific operations by processor 2007 executing one or more sequences of one or more instructions contained in system memory 2008. Such instructions may be read into system memory 2008 from another computer readable/usable medium, such as static storage device 2009 or disk drive 2010. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 2007 for execution. Such a medium may take many forms, including but not limited to, non-volatile media and volatile media. Non-volatile media includes, for example, optical or magnetic disks, such as disk drive 2010. Volatile media includes dynamic memory, such as system memory 2008.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, cloud-based storage, or any other medium from which a computer can read.

In an embodiment of the invention, execution of the sequences of instructions to practice the invention is performed by a single computer system 2000. According to other embodiments of the invention, two or more computer systems 2000 coupled by communication link 2015 (e.g., LAN, PTSN, or wireless network) may perform the sequence of instructions required to practice the invention in coordination with one another.

Computer system 2000 may transmit and receive messages, data, and instructions, including program, i.e., application code, through communication link 2015 and communication interface 2014. Received program code may be executed by processor 2007 as it is received, and/or stored in disk drive 2010, or other non-volatile storage for later execution. Data may be accessed from a database 2032 that is maintained in a storage device 2031, which is accessed using data interface 2033.

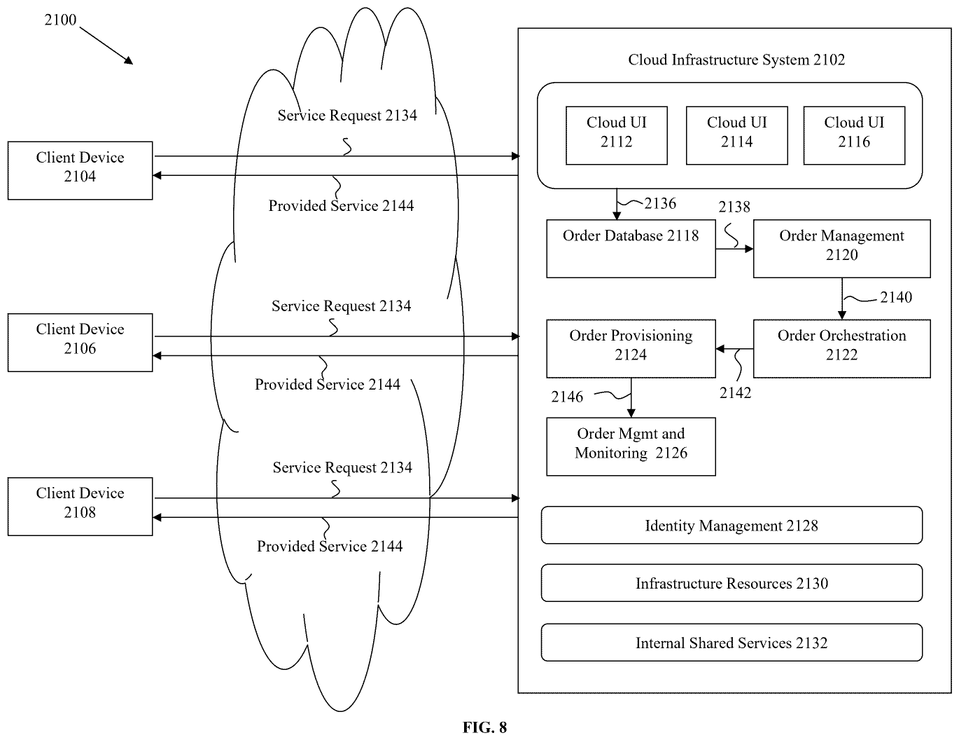

FIG. 8 is a simplified block diagram of one or more components of a system environment 2100 by which services provided by one or more components of an embodiment system may be offered as cloud services, in accordance with an embodiment of the present disclosure. In the illustrated embodiment, system environment 2100 includes one or more client computing devices 2104, 2106, and 2108 that may be used by users to interact with a cloud infrastructure system 2102 that provides cloud services. The client computing devices may be configured to operate a client application such as a web browser, a proprietary client application, or some other application, which may be used by a user of the client computing device to interact with cloud infrastructure system 2102 to use services provided by cloud infrastructure system 2102.

It should be appreciated that cloud infrastructure system 2102 depicted in the figure may have other components than those depicted. Further, the embodiment shown in the figure is only one example of a cloud infrastructure system that may incorporate an embodiment of the invention. In some other embodiments, cloud infrastructure system 2102 may have more or fewer components than shown in the figure, may combine two or more components, or may have a different configuration or arrangement of components.

Client computing devices 2104, 2106, and 2108 may be devices similar to those described above for FIG. 7. Although system environment 2100 is shown with three client computing devices, any number of client computing devices may be supported. Other devices such as devices with sensors, etc. may interact with cloud infrastructure system 2102.

Network(s) 2110 may facilitate communications and exchange of data between clients 2104, 2106, and 2108 and cloud infrastructure system 2102. Each network may be any type of network familiar to those skilled in the art that can support data communications using any of a variety of commercially available protocols. Cloud infrastructure system 2102 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 2102 may include a suite of applications, middleware, and database service offerings that are delivered to a customer in a self-service, subscription-based, elastically scalable, reliable, highly available, and secure manner.

In various embodiments, cloud infrastructure system 2102 may be adapted to automatically provision, manage and track a customer's subscription to services offered by cloud infrastructure system 2102. Cloud infrastructure system 2102 may provide the cloud services via different deployment models. For example, services may be provided under a public cloud model in which cloud infrastructure system 2102 is owned by an organization selling cloud services and the services are made available to the general public or different industry enterprises. As another example, services may be provided under a private cloud model in which cloud infrastructure system 2102 is operated solely for a single organization and may provide services for one or more entities within the organization. The cloud services may also be provided under a community cloud model in which cloud infrastructure system 2102 and the services provided by cloud infrastructure system 2102 are shared by several organizations in a related community. The cloud services may also be provided under a hybrid cloud model, which is a combination of two or more different models.

In some embodiments, the services provided by cloud infrastructure system 2102 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 2102. Cloud infrastructure system 2102 then performs processing to provide the services in the customer's subscription order.

In some embodiments, the services provided by cloud infrastructure system 2102 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 2102 may also include infrastructure resources 2130 for providing the resources used to provide various services to customers of the cloud infrastructure system. In one embodiment, infrastructure resources 2130 may include pre-integrated and optimized combinations of hardware, such as servers, storage, and networking resources to execute the services provided by the PaaS platform and the SaaS platform.

In some embodiments, resources in cloud infrastructure system 2102 may be shared by multiple users and dynamically re-allocated per demand. Additionally, resources may be allocated to users in different time zones. For example, cloud infrastructure system 2130 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 2132 may be provided that are shared by different components or modules of cloud infrastructure system 2102 and by the services provided by cloud infrastructure system 2102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

In certain embodiments, cloud infrastructure system 2102 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 2102, and the like.

In one embodiment, as depicted in the figure, cloud management functionality may be provided by one or more modules, such as an order management module 2120, an order orchestration module 2122, an order provisioning module 2124, an order management and monitoring module 2126, and an identity management module 2128. These modules may include or be provided using one or more computers and/or servers, which may be general purpose computers, specialized server computers, server farms, server clusters, or any other appropriate arrangement and/or combination.

In operation 2134, a customer using a client device, such as client device 2104, 2106 or 2108, may interact with cloud infrastructure system 2102 by requesting one or more services provided by cloud infrastructure system 2102 and placing an order for a subscription for one or more services offered by cloud infrastructure system 2102. In certain embodiments, the customer may access a cloud User Interface (UI), cloud UI 2112, cloud UI 2114 and/or cloud UI 2116 and place a subscription order via these UIs. The order information received by cloud infrastructure system 2102 in response to the customer placing an order may include information identifying the customer and one or more services offered by the cloud infrastructure system 2102 that the customer intends to subscribe to.

After an order has been placed by the customer, the order information is received via the cloud UIs, 2112, 2114 and/or 2116. At operation 2136, the order is stored in order database 2118. Order database 2118 can be one of several databases operated by cloud infrastructure system 2118 and operated in conjunction with other system elements. At operation 2138, the order information is forwarded to an order management module 2120. In some instances, order management module 2120 may be configured to perform billing and accounting functions related to the order, such as verifying the order, and upon verification, booking the order. At operation 2140, information regarding the order is communicated to an order orchestration module 2122. Order orchestration module 2122 may utilize the order information to orchestrate the provisioning of services and resources for the order placed by the customer. In some instances, order orchestration module 2122 may orchestrate the provisioning of resources to support the subscribed services using the services of order provisioning module 2124.

In certain embodiments, order orchestration module 2122 enables the management of business processes associated with each order and applies business logic to determine whether an order should proceed to provisioning. At operation 2142, upon receiving an order for a new subscription, order orchestration module 2122 sends a request to order provisioning module 2124 to allocate resources and configure those resources needed to fulfill the subscription order. Order provisioning module 2124 enables the allocation of resources for the services ordered by the customer. Order provisioning module 2124 provides a level of abstraction between the cloud services provided by cloud infrastructure system 2102 and the physical implementation layer that is used to provision the resources for providing the requested services. Order orchestration module 2122 may thus be isolated from implementation details, such as whether or not services and resources are provisioned on the fly or pre-provisioned and only allocated/assigned upon request.

At operation 2144, once the services and resources are provisioned, a notification of the provided service may be sent to customers on client devices 2104, 2106 and/or 2108 by order provisioning module 2124 of cloud infrastructure system 2102.

At operation 2146, the customer's subscription order may be managed and tracked by an order management and monitoring module 2126. In some instances, order management and monitoring module 2126 may be configured to collect usage statistics for the services in the subscription order, such as the amount of storage used, the amount data transferred, the number of users, and the amount of system up time and system down time.

In certain embodiments, cloud infrastructure system 2102 may include an identity management module 2128. Identity management module 2128 may be configured to provide identity services, such as access management and authorization services in cloud infrastructure system 2102. In some embodiments, identity management module 2128 may control information about customers who wish to utilize the services provided by cloud infrastructure system 2102. Such information can include information that authenticates the identities of such customers and information that describes which actions those customers are authorized to perform relative to various system resources (e.g., files, directories, applications, communication ports, memory segments, etc.) Identity management module 2128 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

Additionally, the approach disclosed herein for hierarchical and distributed metrics aggregation using namespaces for a multitenant autonomous cloud environment addresses at least some of the issues of prior techniques suffer from, by alleviating the necessity manage and maintain each and every metric in anticipation of each and every metric potentially being relevant to a particular process or thread. Instead, the approach provided herein is dynamic in that the metrics that are management can be identified based on the relevant circumstances and track only on an as needed basis at runtime. In this way the approach provided herein enables an improved approach to manage collection of metrics for consolidated databases in a cluster.

What is claimed is:

1. A computer-implemented method comprising:
maintaining metric definitions, metric generation logic, metric modification logic, and metric collection logic;
maintaining a database instance on a computing node;
dynamically monitoring the database instance using one or more metrics objects, wherein the metrics objects are generated at runtime of individual tasks based on metrics definitions, generation, modification, and collection logic; and
processing, based on hierarchical relationships between the one or more metrics objects, at least one task of the one or more tasks upon closing of the at least one task.

2. The method of claim 1, wherein the database instance comprises a consolidated database instance, the consolidated database instance is associated with one or more pluggable database instances, and the computing node is in a cluster of computing nodes.

3. The method of claim 1, wherein generating the metrics objects at the runtime of the individual tasks is further based on metrics object definition templates.

4. The method of claim 1, wherein processing the at least one task of the one or more tasks upon the closing of the at least one task comprises rolling up metrics in the metrics object into another metrics object for a parent task.

5. The method of claim 4, wherein rolling up metrics in the metrics object into another metrics object for a parent task comprises adding an individual metric to a matching parent metric.

6. The method of claim 4, wherein a parent task comprises an immediate parent or a rolling up metrics in the metrics object into another metrics object for a parent task comprises adding an individual metric to a matching parent metric.

7. The method of claim 4, wherein child metrics objects are rolled up into parent metrics objects based on matching metric labels.

8. The method of claim 1, wherein processing the at least one task of the one or more tasks upon the closing of the at least one task comprises applying a retention policy to the metrics object, and a retention policy specifies conditions for storage or removal from storage of a corresponding metrics object.

9. A non-transitory computer readable medium having stored thereon a sequence of instructions which, when executed by a processor causes a set of acts comprising:
maintaining metric definitions, metric generation logic, metric modification logic, and metric collection logic;
maintaining a database instance on a computing node;
dynamically monitoring the database instance using one or more metrics objects, wherein the metrics objects are generated at runtime of individual tasks based on metrics definitions, generation, modification, and collection logic; and
processing, based on hierarchical relationships between the one or more metrics objects, at least one task of the one or more tasks upon closing of the at least one task.

10. The non-transitory computer readable medium of claim 9, wherein the database instance comprises a consolidated database instance, the consolidated database instance is associated with one or more pluggable database instances, and the computing node is in a cluster of computing nodes.

11. The non-transitory computer readable medium of claim 9, wherein generating the metrics objects at the runtime of the individual tasks is further based on metrics object definition templates.

12. The non-transitory computer readable medium of claim 9, wherein processing the at least one task of the one or more tasks upon the closing of the at least one task comprises rolling up metrics in the metrics object into another metrics object for a parent task.

13. The non-transitory computer readable medium of claim 12, wherein rolling up metrics in the metrics object into another metrics object for a parent task comprises adding an individual metric to a matching parent metric.

14. The non-transitory computer readable medium of claim 12, wherein a parent task comprises an immediate parent or a rolling up metrics in the metrics object into another metrics object for a parent task comprises adding an individual metric to a matching parent metric.

15. The non-transitory computer readable medium of claim 12, wherein child metrics objects are rolled up into parent metrics objects based on matching metric labels.

16. The non-transitory computer readable medium of claim 9, wherein processing the at least one task of the one or more tasks upon the closing of the at least one task comprises applying a retention policy to the metrics object, and a retention policy specifies conditions for storage or removal from storage of a corresponding metrics object.

17. A computing system comprising:
a memory to hold a set of instructions;
a computer processor to execute the set of instructions, which when executed cause a set of acts comprising:
maintaining metric definitions, metric generation logic, metric modification logic, and metric collection logic;
maintaining a database instance on a computing node;
dynamically monitoring the database instance using one or more metrics objects, wherein the metrics objects are generated at runtime of individual tasks based on metrics definitions, generation, modification, and collection logic; and
processing, based on hierarchical relationships between the one or more metrics objects, at least one task of the one or more tasks upon closing of the at least one task.

18. The computer system of claim 17, wherein the database instance comprises a consolidated database instance, the consolidated database instance is associated with one or more pluggable database instances, and the computing node is in a cluster of computing nodes.

19. The computing system of claim 17, wherein generating the metrics objects at the runtime of the individual tasks is further based on metrics object definition templates.

20. The computing system of claim 17, wherein processing the at least one task of the one or more tasks upon the closing of the at least one task comprises rolling up metrics in the metrics object into another metrics object for a parent task.
